(19) United States
(12) Patent Application Publication
(10) Pub. No.: US 2013/0332662 A1
(43) Pub. Date: Dec. 12, 2013

(54) INFORMATION PROCESSING APPARATUS AND METHOD AND PROGRAM

(71) Applicant: Sony Corporation, Tokyo (JP)

(72) Inventors: Tomohiro Katori, Tokyo (JP); Hiroki Nagahama, Tokyo (JP)

(21) Appl. No.: 13/910,425

(22) Filed: Jun. 5, 2013

(30) Foreign Application Priority Data
Jun. 12, 2012 (JP) 2012-132557

(51) Int. Cl. G06F 3/06

(52) U.S. Cl. CPC G06F 3/0614; G06F 3/065; G06F 3/0679
USPC 711/103; 711/162; 711/105

(57) ABSTRACT

There is provided an information processing apparatus including a table saving unit configured to copy an address conversion table stored in a first storage area of a memory to a storage area other than the first storage area and save the copied address conversion table, a table recovery unit configured to recover the address conversion table of a saving time point by copying the saved address conversion table to the first storage area of the memory, and a rewrite control unit configured to, when there is a rewrite request for data of a virtual address associated with a physical address on the address conversion table after the address conversion table has been saved, change the physical address associated with the virtual address, and cause the rewritten data to be stored in a storage area corresponding to the changed physical address.

### BACKGROUND

The present technology relates to an information processing apparatus and method and a program, and more particularly to an information processing apparatus and method and a program capable of easily restoring stored contents of a memory at a predetermined timing.

Recently, the development of nonvolatile memories is ongoing.

For example, a magnetoresistive random access memory (MRAM) is memory technology using the same magnetic material as a hard disk for a storage medium. An MRAM uses an effect of tunnel magnetoresistance (TMR) in which a resistance value is varied by sandwiching an insulator thin film having a thickness of about several atoms between magnetic thin films of two layers and varying magnetization directions applied from both sides.

For an MRAM, an address access time is about 10 ns, a cycle time is about 20 ns, and reading/writing can be performed at a speed about five times faster than that of a dynamic random access memory (DRAM). In addition, there is an advantage in that low power consumption of about 1/10 of a flash memory and high integration are possible.

In addition, a resistance random access memory (ReRAM) uses a large change in electric resistance due to voltage application (a large resistance change in electric field induction or an effect of colossal electro-resistance (CER)).

A ReRAM has a small cell area because of a relatively simple structure and hence a high density (=low cost) can be formed. In addition, because a change rate in electric resistance is increased by a factor of several tens and multi-value is easily formed, a large capacity can be expected.

For example, if contents of a main memory are stored in a nonvolatile memory, data being processed can also be saved and reused.

In addition, technology for enabling data of a saving time point to be written to a separate area within a swap as a position of the data desired to be left when contents of a main memory of a certain time point are written to and saved in the swap area and a page saved in the swap is updated has been proposed (for example, see JP H2-16655A).

### SUMMARY

However, the technology of JP H2-16655A assumes that there is a device capable of obtaining the swap area such as an external storage.

In addition, it is difficult to use the technology of JP H2-16655A under a situation in which a page-in and a page-out do not occur because an operation is performed using the page-in or the page-out as a trigger.

It is desirable to easily restore stored contents of a memory at a predetermined timing.

According to an embodiment of the present disclosure, there is provided an information processing apparatus including a table saving unit configured to copy an address conversion table stored in a first storage area of a memory to a storage area other than the first storage area and save the copied address conversion table, a table recovery unit configured to recover the address conversion table of a saving time point by copying the saved address conversion table to the first storage area of the memory, and a rewrite control unit configured to, when there is a rewrite request for data of a virtual address associated with a physical address on the address conversion table after the address conversion table has been saved, change the physical address associated with the virtual address, and cause the rewritten data to be stored in a storage area corresponding to the changed physical address.

The address conversion table may be generated for an application program. The information processing apparatus may further include a program notification unit configured to specify an application program to be executed and notify the table recovery unit of the specified application program. The table recovery unit may recover the address conversion table of the saving time point when the address conversion table corresponding to the application program is saved at a point in time at which the application program is executed.

The program notification unit may further sense an end of the execution of the application program and notifies the rewrite control unit of the sensed execution end. The rewrite control unit may erase the rewritten data stored in the storage area corresponding to the changed physical address when notified of the end of the execution of the application program.

The information processing apparatus may further include an execution presence/absence information notification unit configured to notify the table recovery unit of information indicating whether the application program has been previously executed when the application program is executed. The table recovery unit may recover the address conversion table when notified of the information indicating whether the application program has been previously executed.

The memory may be a nonvolatile memory.

The information processing apparatus may further include a memory holding unit configured to supply power to the memory. The memory may be a volatile memory.

The table saving unit may save the address conversion table at a predetermined time interval.

The table saving unit may save the address conversion table when a predetermined event has been generated while an application program is in operation.

The table saving unit may save the address conversion table at a plurality of time points. The table recovery unit may recover an address conversion table of a designated time point among address conversion tables of the plurality of time points.

The address recovery unit may recover an address conversion table of a designated time point based on an operation of a user. When the address conversion table of the designated time point is not saved, the address recovery unit may control a display of a message for notifying the user that the address conversion table is not capable of being recovered.

According to an embodiment of the present disclosure, there is provided an information processing method including copying, by a table saving unit, an address conversion table stored in a first storage area of a memory to a storage area other than the first storage area and saving the copied address conversion table, recovering, by a table recovery unit, the address conversion table of a saving time point by copying the saved address conversion table to the first storage area of the memory, and changing, by a rewrite control unit, when there is a rewrite request for data of a virtual address associated with a physical address on the address conversion table after the address conversion table has been saved, the physical address associated with the virtual address, and causing the rewritten data to be stored in a storage area corresponding to the changed physical address.

According to an embodiment of the present disclosure, there is provided a program for causing a computer to function as an information processing apparatus, the information processing apparatus including a table saving unit configured to copy an address conversion table stored in a first storage area of a memory to a storage area other than the first storage area and save the copied address conversion table, a table recovery unit configured to recover the address conversion table of a saving time point by copying the saved address conversion table to the first storage area of the memory, and a rewrite control unit configured to, when there is a rewrite request for data of a virtual address associated with a physical address on the address conversion table after the address conversion table has been saved, change the physical address associated with the virtual address, and cause the rewritten data to be stored in a storage area corresponding to the changed physical address.

According to an embodiment of the present disclosure, a table saving unit may be configured to copy an address conversion table stored in a first storage area of a memory to a storage area other than the first storage area and save the copied address conversion table. A table recovery unit may be configured to recover the address conversion table of a saving time point by copying the saved address conversion table to the first storage area of the memory. A rewrite control unit may be configured to, when there is a rewrite request for data of a virtual address associated with a physical address on the address conversion table after the address conversion table has been saved, change the physical address associated with the virtual address, and cause the rewritten data to be stored in a storage area corresponding to the changed physical address.

In accordance with the embodiments of the present technology described above, it is possible to easily restore stored contents of a memory at a predetermined timing.

### BRIEF DESCRIPTION OF THE DRAWINGS

FIG. 1 is a block diagram illustrating a configuration example of a calculation processing system in accordance with an embodiment of the present technology;

FIG. 2 is a block diagram illustrating a functional configuration example of a central processing unit (CPU), a memory management unit (MMU), and a random access memory (RAM) of FIG. 1;

FIG. 3 is a diagram illustrating association of a virtual address and a physical address;

FIG. 4 is a diagram illustrating association of a virtual address and a physical address after data rewriting in an embodiment of the present technology;

FIG. 5 is a diagram illustrating association of a virtual address and a physical address after data rewriting in the related art;

FIG. 6 is a diagram illustrating association of a virtual address and a physical address after data writing in the related art;

FIG. 7 is a block diagram illustrating another functional configuration example of the CPU, the MMU, and the RAM of FIG. 1;

FIG. 8 is a flowchart illustrating an example of an address conversion table management process;

FIG. 9 is a flowchart illustrating an example of a table saving control process;

FIG. 10 is a flowchart illustrating an example of a table recovery control process;

FIG. 11 is a flowchart illustrating an example of a service start-up control process;

FIG. 12 is a block diagram illustrating still another functional configuration example of the CPU, the MMU, and the RAM of FIG. 1; and

FIG. 13 is a block diagram illustrating a configuration example of a personal computer (PC).

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, embodiments of the present technology will be described in detail with reference to the appended drawings.

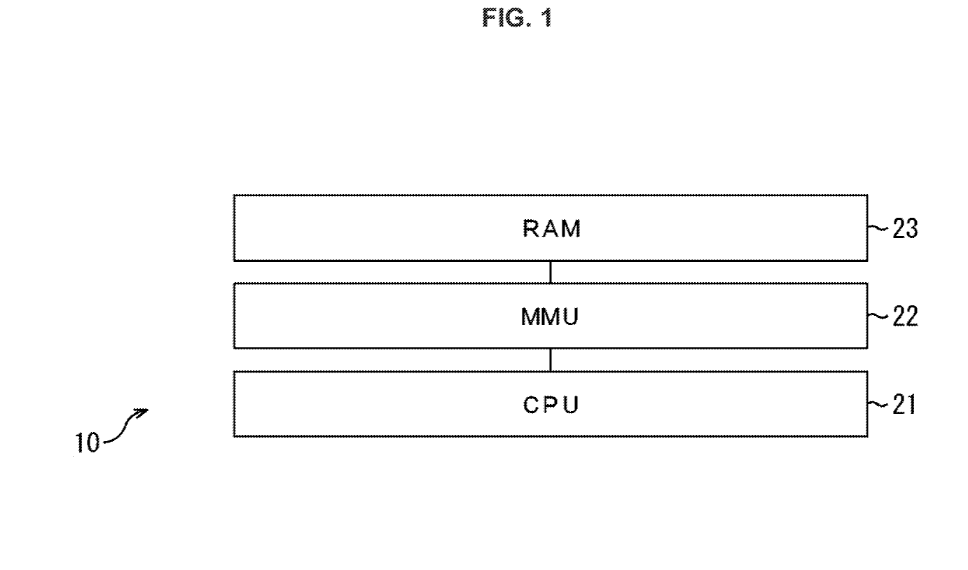

FIG. 1 is a block diagram illustrating a configuration example of a calculation processing system in accordance with an embodiment of the present technology.

The calculation processing system 10 illustrated in FIG. 1 includes a CPU 21, an MMU 22, and a RAM 23. The calculation processing system 10, for example, is implemented in a portable telephone, a smart phone, and the like, and configured to execute a downloaded application program or the like.

Here, for example, a magnetoresistive RAM (MRAM) or the like is configured as a nonvolatile memory.

The RAM 23 is provided as a primary storage apparatus (main memory) corresponding to the CPU 21 and data is set to be written or read based on control of the MMU 22. The MMU 22 has functions related to conversion of a virtual address and a physical address, memory protection, and the like, and serves as a functional block that executes a process related to memory access control of the CPU 21. The MMU 22, for example, may be configured as part of the CPU 21.

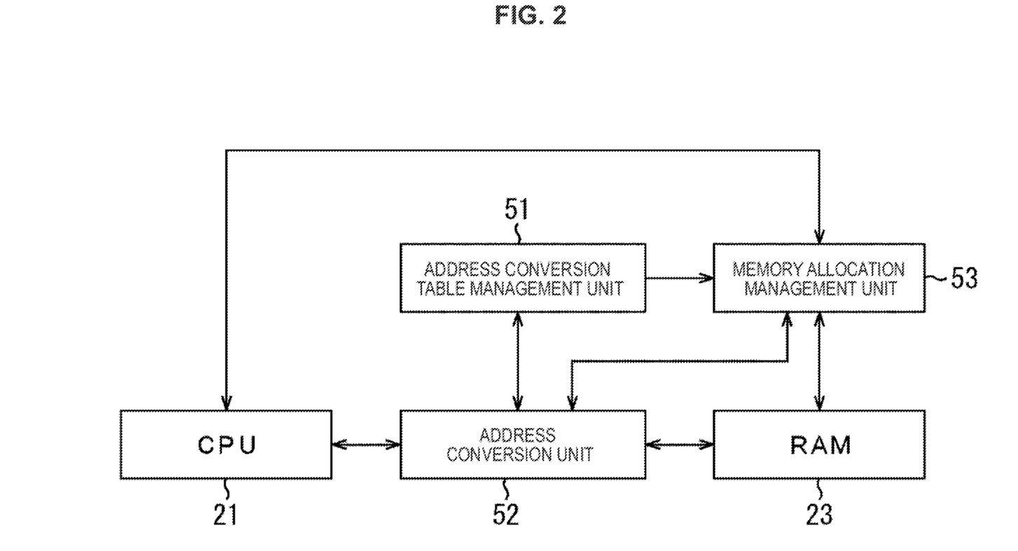

FIG. 2 is a block diagram illustrating a functional configuration example of the CPU 21, the MMU 22, and the RAM 23 of FIG. 1. In this example, an address conversion table management unit 51, an address conversion unit 52, and a memory allocation management unit 53 are illustrated in addition to the CPU 21 and the RAM 23.

The address conversion unit 52 converts a virtual address supplied from the CPU 21 into a physical address based on an address conversion table. Thereby, the CPU 21 acquires a physical address related to corresponding data, and outputs an access request for the physical address to the memory allocation management unit 53.

Here, the address conversion table is a table in which a virtual space address is associated with a physical space address of the RAM 23, and is stored in a storage area of part of the RAM 23.

In addition, the address conversion table management unit 51 causes contents of the address conversion table of a predetermined time point to be stored in another part of the RAM 23.

For example, the address conversion table to be referred to by the address conversion unit 52 is part of the storage area of the RAM 23, and is stored in a storage area to be used as a work area. On the other hand, the address conversion table management unit 51 copies an address conversion table of a predetermined time point to a storage area different from a work area.

The address conversion table management unit 51, for example, copies an address conversion table of a point in time at which data or the like related to an application program to be executed by the CPU 21 has been loaded to the RAM 23 to a storage area different from a work area.

In FIG. 2, the CPU 21 executes an application program or the like and outputs a write command, a read command, or the like for necessary data or the like during processing to the memory allocation management unit 53. The memory allocation management unit 53 controls access to the RAM 23, and controls an operation of reading or writing data according to a request of the CPU 21.

For example, when necessary data during processing is read from the RAM 23, the CPU 21 supplies a virtual address, which specifies a storage position of the data to the address conversion unit 52, and requests conversion of the virtual address into a physical address. The address conversion unit 52 converts the virtual address into the physical address, and supplies the physical address to the CPU 21.

The CPU 21 requests the memory allocation management unit 53 to read data based on the physical address acquired as described above.

The memory allocation management unit 53 is a storage area corresponding to the physical address supplied from the CPU 21, and controls reading of data from a predetermined storage area of the RAM 23.

In addition, for example, when data read from the RAM 23 is rewritten while an application program is in operation, the CPU 21 supplies a virtual address, which specifies a storage position of the data, to the address conversion unit 52, and requests conversion of the virtual address into a physical address. Therefore, the CPU 21 requests the memory allocation management unit 53 to write data.

At this time, the address conversion unit 52 notifies the memory allocation management unit 53 of writing to the physical address already associated with the virtual address.

In this case, the memory allocation management unit 53 controls the data to be stored in a new storage area of the RAM 23 without rewriting to a storage area corresponding to a physical address acquired based on the address conversion table. Therefore, the memory allocation management unit 53 notifies the address conversion unit 52 of the physical address corresponding to the newly allocated storage area.

The address conversion unit 52 updates information of the address conversion table so that a new physical address of the notification as described above is associated with a virtual address.

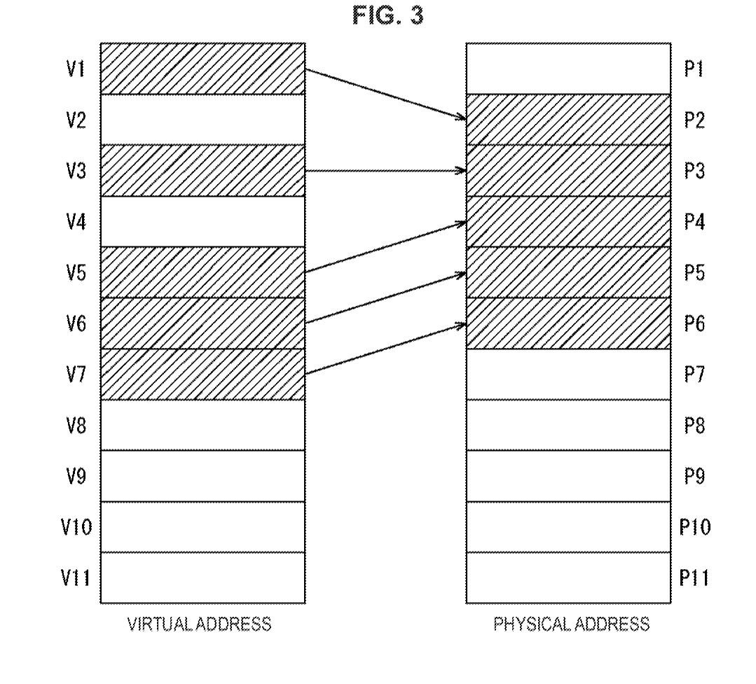

For example, as illustrated in FIG. 3, it is assumed that virtual addresses are already associated with physical addresses in the address conversion table. In the example of FIG. 3, a virtual address V1 is associated with a physical address P2. Likewise, virtual addresses V3, V5, V6, and V7 are associated with physical addresses P3, P4, P5, and P6, respectively.

Here, it is assumed that there is a rewrite request of data corresponding to the virtual address V6 according to a process of an application program in operation in the CPU 21. Also, at this time point, it is assumed that the address conversion table of the state illustrated in FIG. 3 is already copied by the address conversion table management unit 51.

At this time, as described above, the address conversion unit 52 notifies the memory allocation management unit 53 of writing to a physical address already associated with a virtual address.

The memory allocation management unit 53 controls data to be stored in a new storage area of the RAM 23 without rewriting to a storage area corresponding to a physical address acquired based on the address conversion table. For example, a storage area corresponding to a physical address P7 is newly allocated as a storage area for storing rewritten data.

Therefore, the memory allocation management unit 53 notifies the address conversion unit 52 of the physical address P7 corresponding to the newly allocated storage area.

The address conversion unit 52 updates information of the address conversion table so that the new physical address P7 of the notification as described above is associated with the virtual address V6.

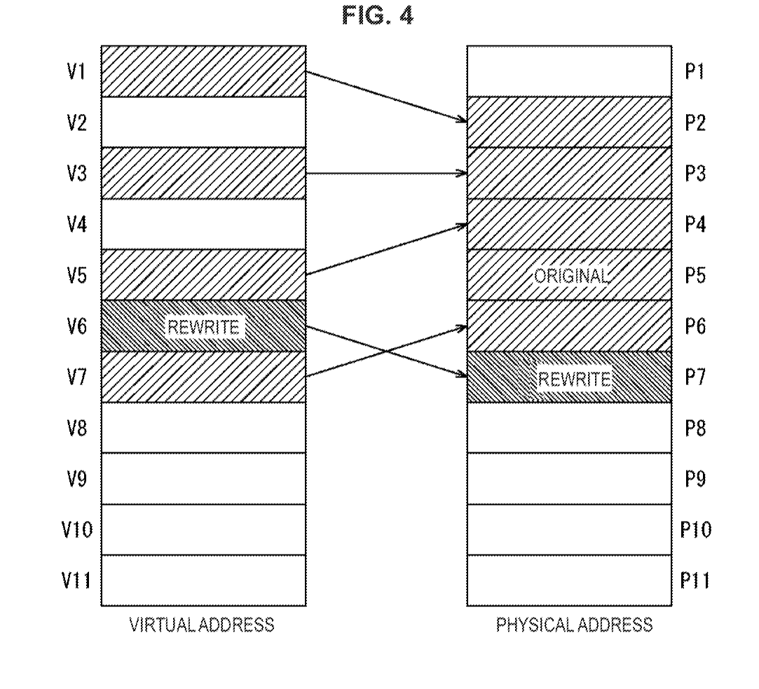

Thereby, for example, as illustrated in FIG. 4, the association of the virtual address and the physical address by the address conversion table is changed. In the example of FIG. 4, a change is made so that the virtual address V6 associated with the physical address P5 in FIG. 3 is newly associated with the physical address P7.

In addition, in FIG. 4, data stored in the physical address P5 remains in its original state without being erased or changed.

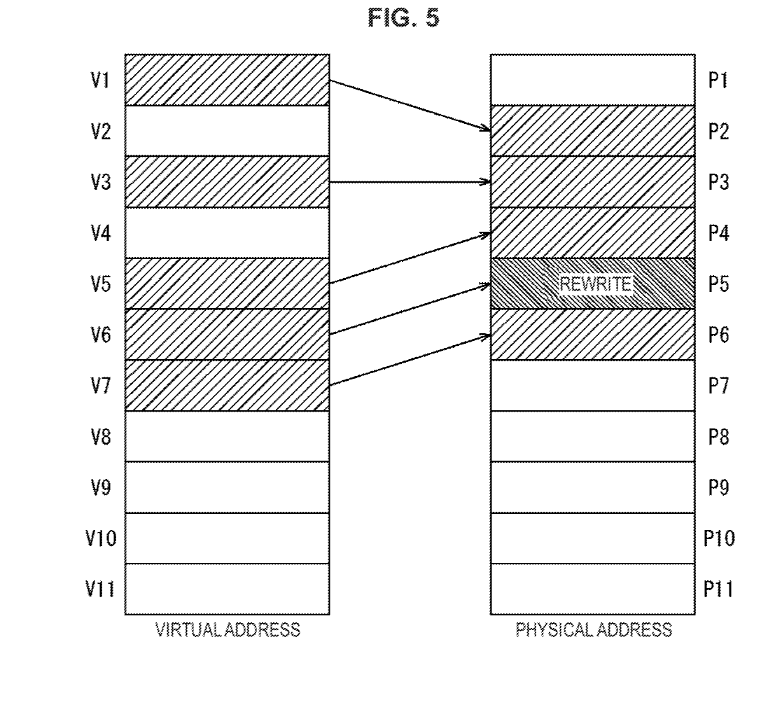

When data is rewritten in the case of the related art, data stored in the physical address P5 is rewritten and the virtual address V6 remains in association with the physical address P5 as illustrated in FIG. 5.

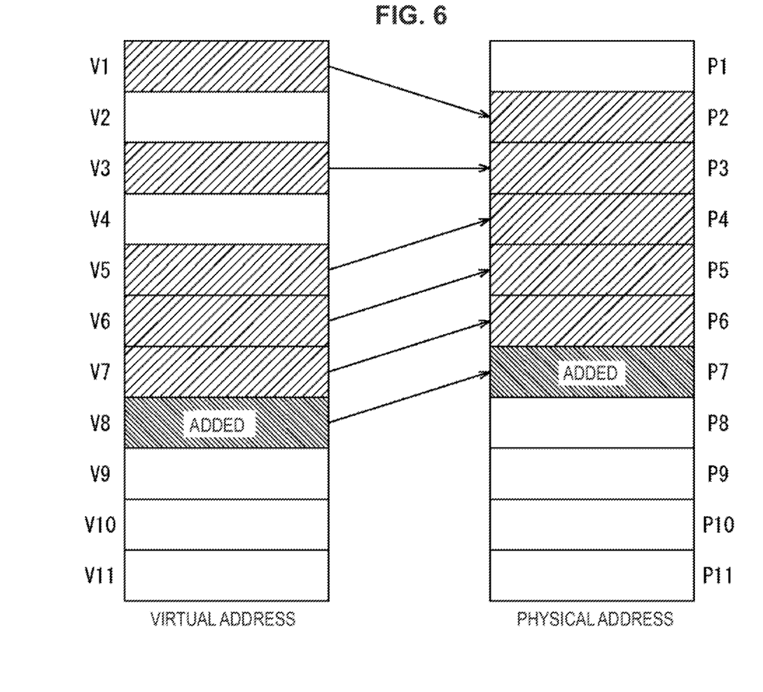

In addition, when new data is written in the case of the related art, for example, a storage area corresponding to the physical address P7 is allocated as a new storage area of the RAM 23, and new data is written thereto as illustrated in FIG. 6. Therefore, the physical address P7, for example, is associated with a new virtual address V8.

On the other hand, in the present technology, a new physical address for storing rewritten data is allocated when a write request for a physical address already associated with a virtual address has been generated after the address conversion table has been copied by the address conversion table management unit 51. In addition, in the present technology, contents of a storage area corresponding to an original physical address remain in their original state when rewritten data has been stored in a physical address newly allocated as described above.

For example, when a game is started up in a smart phone or the like, it is necessary to load data related to an application program to the RAM. In this case, it is necessary to generate an address conversion table in which a physical address of the RAM is associated with a virtual address.

In the related art, the address conversion table is erased every time the execution of an application program ends. Because the RAM (primary storage apparatus) of the related art normally has a volatile memory and all stored contents are erased according to power OFF or the like, an address conversion table is generally generated every time data related to an application program is loaded to the RAM.

However, because stored contents are held even after power OFF when a nonvolatile memory is used as the primary storage apparatus, the data of the storage area can be directly used without being erased.

That is, data related to an application program once loaded to the storage area can be reused when the execution of the application program ends once and the application program is executed again.

When data related to the application program is normally loaded, the address conversion table related to the application program is generated in a work area. Accordingly, if the address conversion table at that time point is copied to a storage area other than the work area, for example, it is not necessary to execute a process of loading data related to the application program or the like every time a game is started up. That is, it is possible to restore a state immediately after data related to the application program has been loaded by merely copying the address conversion table saved in the storage area other than the work area to the work area when the game started up once is restarted.

Therefore, in the present technology, a new physical address for storing rewritten data is set to be allocated when a write request for the physical address already associated with the virtual address has been generated after the address conversion table has been copied (saved) by the address conversion table management unit 51 as described above. In addition, when data rewritten to the newly allocated physical address has been stored, contents of a storage area corresponding to an original physical address are set to remain as the original.

Thereby, for example, it is possible to significantly shorten a necessary time when some function is started up in a device in which a calculation processing system is implemented or the like.

Alternatively, the present technology can enable an address conversion table to be recovered at a desired time point. For example, recovery can be enabled early when power discontinuity has occurred in a device in which the calculation processing system is implemented or the like.

For example, when power discontinuity has occurred while a user of a smart phone is playing a game, an application program corresponding to the game is first restarted and a progress state of the game is restored from saved data in a scheme of the related art. In this case, a process of loading data related to an application program or the like is also executed and hence the user waits during this period.

In the present technology, it is possible to restore a state before the occurrence of power discontinuity by copying an address conversion table saved in a storage area other than a work area to the work area as described above.

In this case, the address conversion table management unit 51, for example, saves the address conversion table in a fixed cycle as well as at a point in time at which data related to the application program has been loaded. Alternatively, for example, the address conversion table may be set to be saved every time a specific event or the like is generated in the game.

In addition, in this case, because the address conversion table is saved a plurality of times, when the address conversion table management unit 51 saves the address conversion table, overwriting on the address conversion table saved so far may be set to be performed, and the address conversion table may be set to be saved at each of a plurality of time points.

Therefore, when the power discontinuity is caused and removed, the address conversion table management unit 51 copies the saved address conversion table to the work area. Also, because the RAM 23 is the nonvolatile memory, stored contents are not lost due to the occurrence of the power discontinuity. In addition, because a new physical address for storing rewritten data is allocated when a write request for a physical address already associated with a virtual address has been generated after the address conversion table has been saved as described above, it is possible to read desired data based on the saved address conversion table.

Thereby, for example, it is possible to perform recovery early when power discontinuity has occurred in a device in which the calculation processing system is implemented or the like.

Alternatively, the address conversion table of a predetermined time point may be set to be copied to the work area, for example, based on the user's command or the like, regardless of the presence/absence of occurrence of power discontinuity. That is, through the present technology, for example, it is possible to recover a progress state of a game to a state of an arbitrary time point.

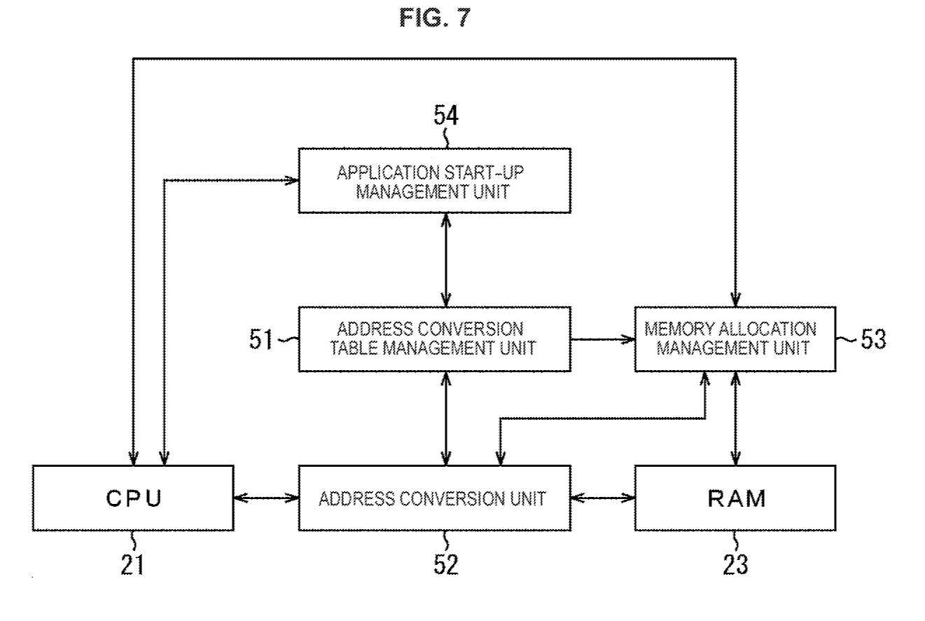

FIG. 7 is a block diagram illustrating another functional configuration example of the CPU 21, the MMU 22, and the RAM 23 of FIG. 1. In this example, an application start-up management unit 54 is illustrated in addition to the address conversion table management unit 51, the address conversion unit 52, and the memory allocation management unit 53 as well as the CPU 21 and the RAM 23.

In the example of FIG. 7, it is assumed that a plurality of application programs are installed in advance in a device such as a smart phone in which the calculation processing system 10 is implemented. Also, the application program includes an application program installed before a device is shipped, an application program downloaded by the user thereafter, and the like.

For example, when the user operates a graphical user interface (GUI) and the like of a smart phone, services (for example, a game, a short message service (SMS), and the like) corresponding to a plurality of application programs are simultaneously provided. In this case, for example, the CPU executes a process corresponding to each application program while switching the process.

In the configuration of FIG. 7, the application start-up management unit 54 is configured to output notification for the start-up of an application program corresponding to a corresponding service to the address conversion table management unit 51 when a command for the start-up of a predetermined service is issued. Also, at this time, the output start-up notification includes an identifier (ID) of the application program and information indicating whether the application program has been previously executed.

When the start-up notification has been received from the application start-up management unit 54, the address conversion table management unit 51 determines whether the application program has been previously executed.

When the application program has been previously executed, the address conversion table management unit 51 copies the address conversion table saved in association with the ID of the application program to a work area of the RAM 23.

When the application program has not been previously executed, data related to the application program is loaded to the RAM. Therefore, the address conversion table management unit 51 copies the address conversion table of a point in time at which the data related to the application program has been loaded to a storage area other than the work area of the RAM 23. Here, the copied address conversion table is saved in association with the ID of the application program.

That is, in the case of the configuration of FIG. 7, an address conversion table is generated and saved for each application program and address conversion tables in which IDs of application programs corresponding to services are associated are read whenever various services are started up.

Thereby, for example, it is possible to significantly shorten start-up times of various services in the smart phone and improve operability.

In addition, when a command for the end of a predetermined service is issued, the application start-up management unit 54 may be set to output notification of the end of an application program corresponding to the service to the address conversion table management unit 51. Also, the end notification output at this time includes an ID of the application program and information indicating whether the application program has been previously executed.

When the application program has been previously executed, the address conversion table management unit 51 notifies the memory allocation management unit 53 of an address and the like of a storage area in which an address conversion table associated with the ID of the application program is saved.

The memory allocation management unit 53 specifies newly written data while an application program is in operation by comparing an address conversion table of a service end time point to an address conversion table saved by the address conversion table management unit 51. For example, in the case of the example described above with reference to FIGS. 3 and 4, it is possible to specify that data stored in the storage area corresponding to the physical address P7 is data newly written while the application program is in operation.

The memory allocation management unit 53 erases data newly written while the application program is in operation specified as described above. For example, in FIG. 4, data stored in the storage area corresponding to the physical address P7 is erased. Thereby, stored contents of physical addresses P1 to P11 have the same states as in FIG. 3.

Thereby, for example, it is possible to prevent unnecessary data from being accumulated in the storage area of the RAM 23.

Because the configurations of other parts in FIG. 7 are substantially the same as described above with reference to FIG. 2, detailed description thereof is omitted.

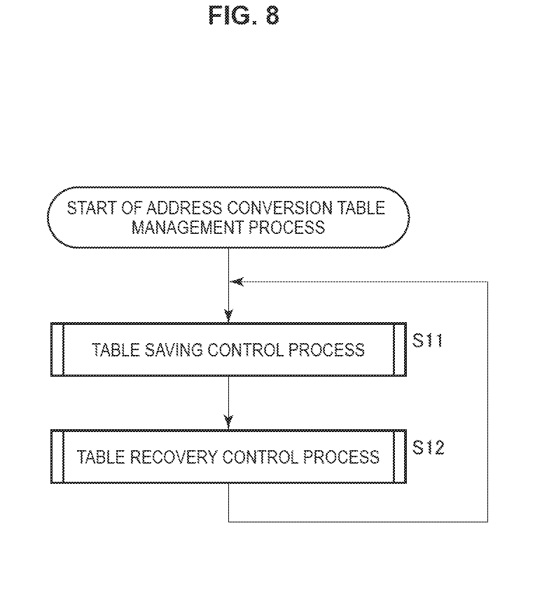

Next, an example of an address conversion table management process by the calculation processing system 10 to which the present technology has been applied will be described with reference to the flowchart of FIG. 8.

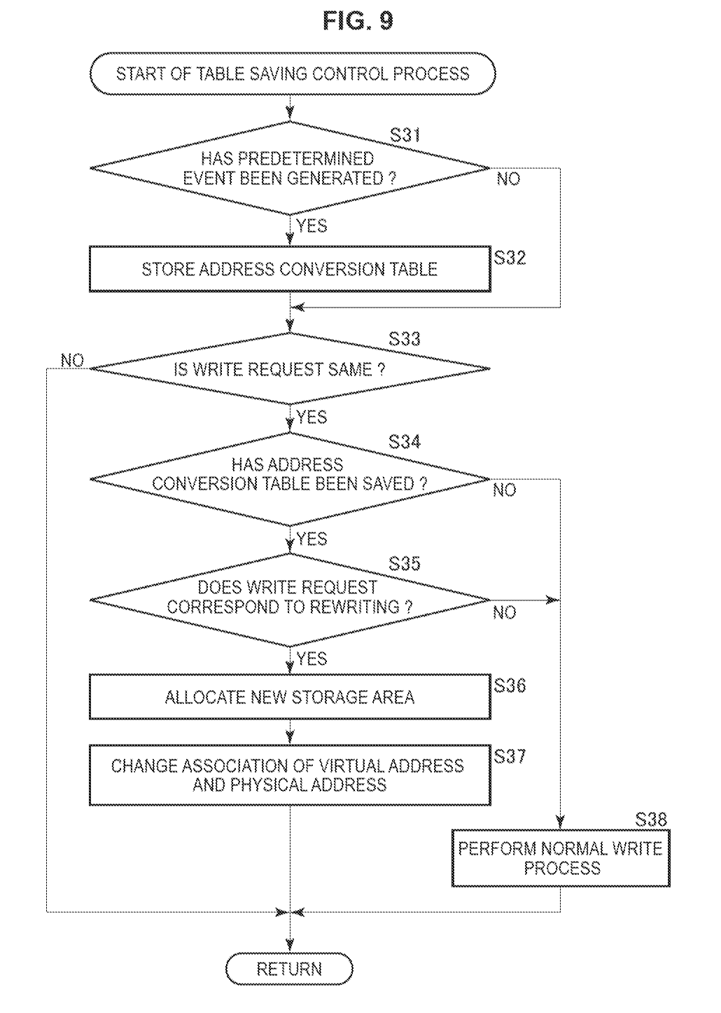

In step S11, the calculation processing system 10 executes a table saving control process as will be described later with reference to the flowchart of FIG. 9.

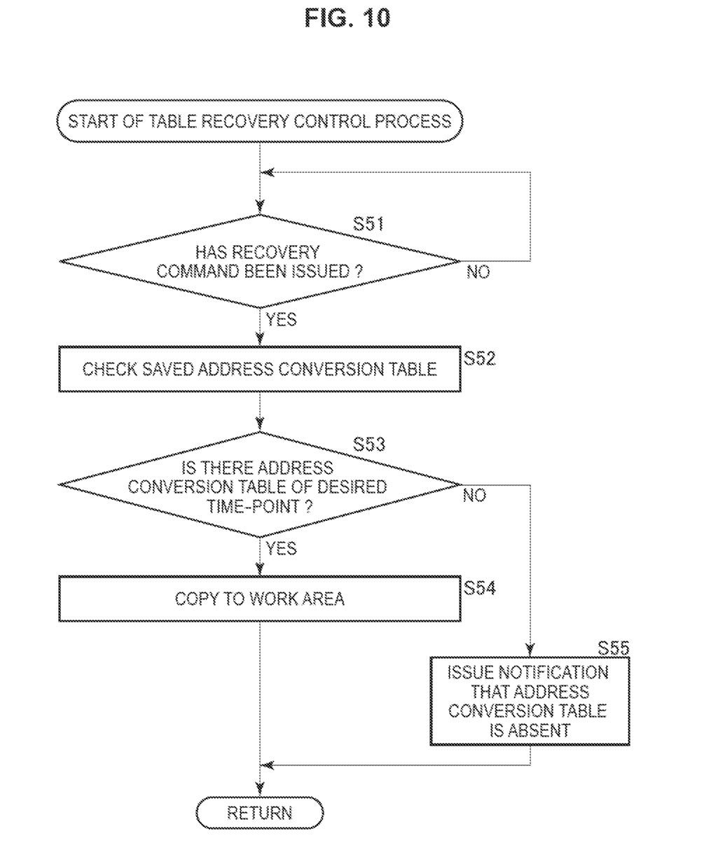

In step S12, the calculation processing system 10 executes a table recovery control process as will be described later with reference to the flowchart of FIG. 10.

Next, a detailed example of the table saving control process of step S11 of FIG. 8 will be described with reference to the flowchart of FIG. 9.

In step S31, the address conversion table management unit 51 determines whether a predetermined event set in advance has been generated. The predetermined event may be set to be generated, for example, using the passage of a predetermined time as a trigger, and may be set to be generated when a predetermined step is executed in a program.

When the predetermined event is determined to have been generated in step S31, the process proceeds to step S32.

In step S32, the address conversion table management unit 51 saves the address conversion table. At this time, for example, the address conversion table is copied to a storage area other than the work area of the RAM 23. Also, the address conversion table, for example, is stored in the storage area other than the work area of the RAM 23 in association with a saved time.

On the other hand, when the predetermined event is determined not to have been generated in step S31, the process of step S32 is skipped.

In step S33, the CPU 21 determines, for example, whether there is a write request for data by a process of a program in operation.

When the write request is determined to be present in step S33, the process proceeds to step S34. At this time, for example, a virtual address, which specifies a storage position of corresponding data, is supplied to the address conversion unit 52 and conversion of the virtual address into a physical address is requested. Therefore, the CPU 21 requests the memory allocation management unit 53 to write the data.

In step S34, the address conversion table management unit 51 determines whether an address conversion table has already been saved. When the address conversion table is determined to have been saved in step S34, the process proceeds to step S35.

In step S35, the address conversion unit 52 determines whether the write request determined by the process of step S33 corresponds to writing to a physical address already associated with a virtual address, that is, whether the write request corresponds to rewriting of the data. When the rewriting is determined in step S35, the memory allocation management unit 53 is notified of the rewriting and the process proceeds to step S36.

In step S36, the memory allocation management unit 53 allocates a new storage area of the RAM 23 for rewritten data. That is, the memory allocation management unit 53 controls the data to be stored in the new storage area of the RAM 23 without rewriting to a storage area corresponding to a physical address acquired based on the address conversion table. Therefore, the address conversion unit 52 is notified of the physical address corresponding to the newly allocated storage area.

In step S37, the address conversion unit 52 updates information of the address conversion table so that a new physical address of the notification according to the process of step S36 is associated with a virtual address.

Thereby, for example, the information of the address conversion table is updated as described above with reference to FIG. 4.

On the other hand, when the address conversion table is determined not to have been saved in step S34 or when the write request is determined not to correspond to rewriting in step S35, the process proceeds to step S38.

In step S38, the memory allocation management unit 53 performs a normal write process. That is, when the write request determined in the process of step S33 is a write request for new data, the new storage area of the RAM 23 is allocated and new data is written to the storage area. In addition, when the write request determined in the process of step S33 corresponds to the rewriting, data of a physical address specified based on the address conversion table is rewritten.

Thereby, for example, the information of the address conversion table is updated as described above with reference to FIGS. 5 and 6.

Thereby, the table saving control process is executed.

Next, a detailed example of the table recovery control process of step S12 of FIG. 8 will be described with reference to the flowchart of FIG. 10. This process, for example, is executed in parallel with the process described with reference to FIG. 8.

In step S51, the address conversion table management unit 51 determines whether there is a command for the recovery of an address conversion table, and waits until the recovery command is determined to be present.

For example, after power discontinuity has been removed or when the user has performed a predetermined operation, the command for the recovery of the address conversion table is output from the CPU 21. In step S51, when the command for the recovery of the address conversion table is determined to be present, the process proceeds to step S52.

In step S52, the address conversion table management unit 51 checks a saved address conversion table.

In step S53, the address conversion table management unit 51 determines whether there is an address conversion table of a predetermined time point as the result of the process of step S52.

When the address conversion table of the predetermined time point is determined to be present in step S53, the process proceeds to step S54.

In step S54, the address conversion table management unit 51 copies the saved address conversion table to the work area. Thereby, the address conversion table of a desired time point is recovered. For example, it is possible to return a service provided by a device in which the calculation processing system 10 is implemented to a state before the power discontinuity occurs or restore the progress of a game to a desired time point.

On the other hand, when the address conversion table of the desired time point is determined to be absent in step S53, the process proceeds to step S55.

In step S55, the address conversion table management unit 51 notifies the CPU 21 that the address conversion table of the desired time point is absent. Thereby, the CPU 21, for example, controls a display of a message for notifying the user that it is difficult to execute a process of reloading data related to an application program or that it is difficult to make a recovery to a desired time point.

Thereby, the table recovery control process is executed.

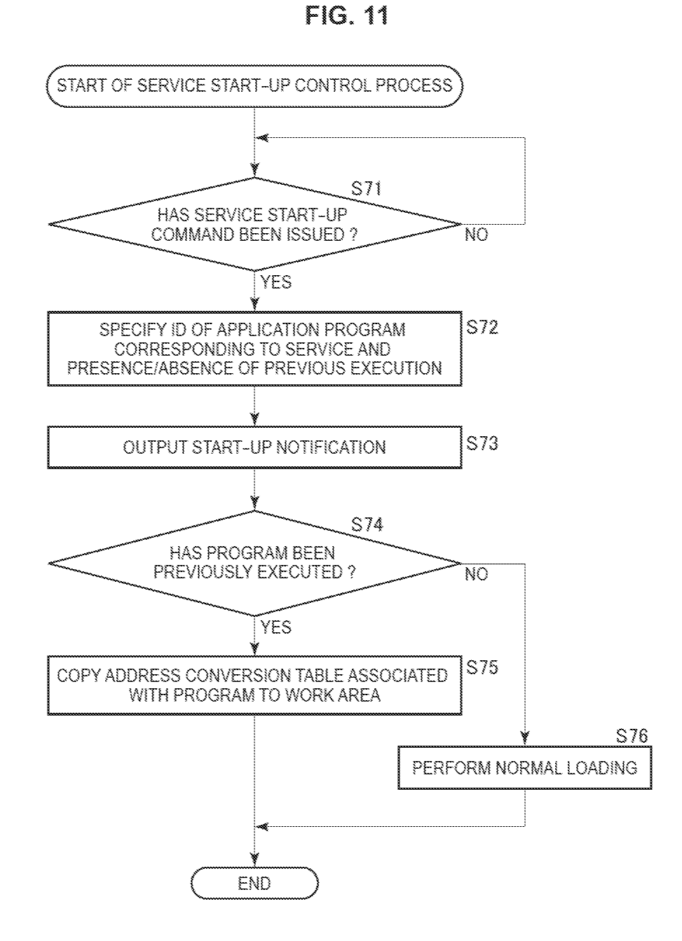

Next, an example of a service start-up control process by the calculation processing system 10 to which the present technology has been applied will be described with reference to the flowchart of FIG. 11. This process is a process corresponding to a configuration described above with reference to FIG. 7. In this case, it is assumed that the address conversion table is generated and saved for each application program.

In step S71, the CPU 21 determines whether a command for the start-up of a predetermined service has been issued, and waits until the command for the start-up of the predetermined service has been issued.

When the command for the start-up of the predetermined service is determined to have been issued in step S71, the process proceeds to step S72.

In step S72, the CPU 21 specifies an ID of an application program corresponding to the started-up service and the presence/absence of previous execution.

In step S73, the CPU 21 outputs notification for the start-up of an application program corresponding to the service to the address conversion table management unit 51. Also, at this time, the output start-up notification includes an ID of the application program and information indicating whether the application program has been previously executed.

In step S74, the address conversion table management unit 51 determines whether the application program has been previously executed.

When the application program is determined to have been previously executed in step S74, the process proceeds to step S75.

In step S75, the address conversion table management unit 51 copies the address conversion table saved in association with the ID of the application program to a work area of the RAM 23.

On the other hand, when the application program is determined not to have been previously executed in step S74, the process proceeds to step S76.

In step S76, data related to the application program is loaded to the RAM. Therefore, the address conversion table management unit 51 copies the address conversion table of a point in time at which the data related to the application program has been loaded to a storage area other than the work area of the RAM 23. Here, the copied address conversion table is saved in association with the ID of the application program.

Thereby, the service start-up control process is executed.

Although the description has been given above under the assumption that the RAM 23, which is the primary storage apparatus in the calculation processing system 10 to which the present technology is applied, has a nonvolatile memory, the present technology is applicable even when the RAM 23 has a volatile memory.

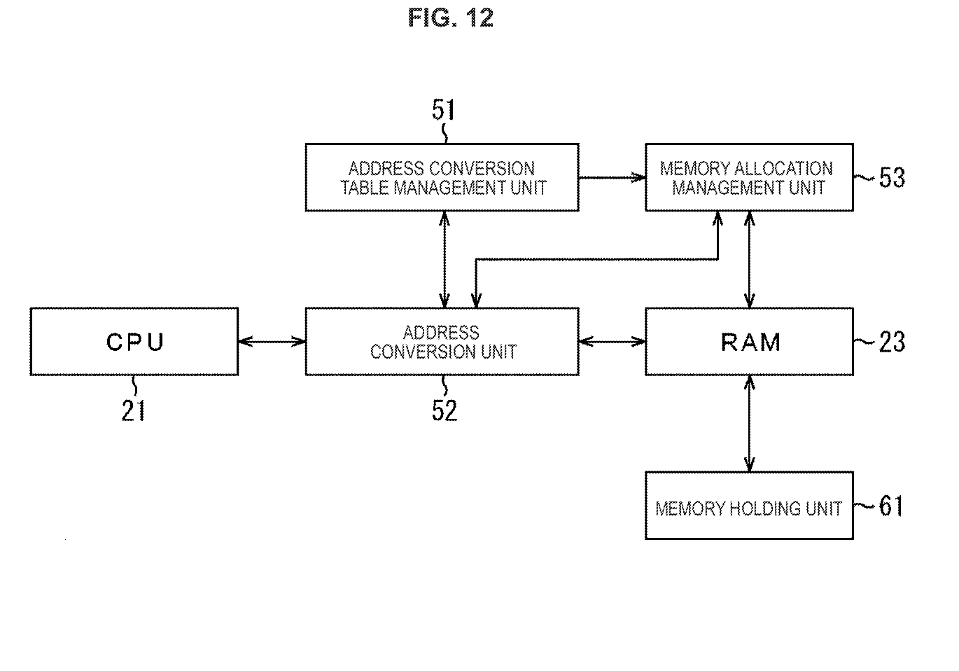

FIG. 12 is a block diagram illustrating still another functional configuration example of the CPU 21, the MMU 22, and the RAM 23 of FIG. 1. In this example, a memory holding unit 61 is illustrated in addition to the address conversion table management unit 51, the address conversion unit 52, and the memory allocation management unit 53 as well as the CPU 21 and the RAM 23.

Also, in the case of the configuration of FIG. 12, the RAM 23 is assumed to have a nonvolatile memory such as a dynamic RAM (DRAM).

The memory holding unit 61 is configured to supply power to the RAM 23, for example, when supply of power to the calculation processing system 10 is stopped. Thereby, even when the RAM 23 has the volatile memory, the RAM can function as the nonvolatile memory and the present technology is applicable.

Because the configurations of other parts in FIG. are substantially the same as described above with reference to FIG. 2, detailed description thereof is omitted.

In addition, the description has been given above under the assumption that the address conversion table is copied and saved from the work area within the memory included in the primary storage apparatus to an area other than the work area. However, for example, the address conversion table may be set to be copied and saved from the memory included in the primary storage apparatus to an auxiliary storage apparatus, a memory inside an MMU, or the like. Further, the address conversion table stored in a memory or the like other than the primary storage apparatus may be set to be copied to and saved in the auxiliary storage apparatus or the memory inside the MMU.

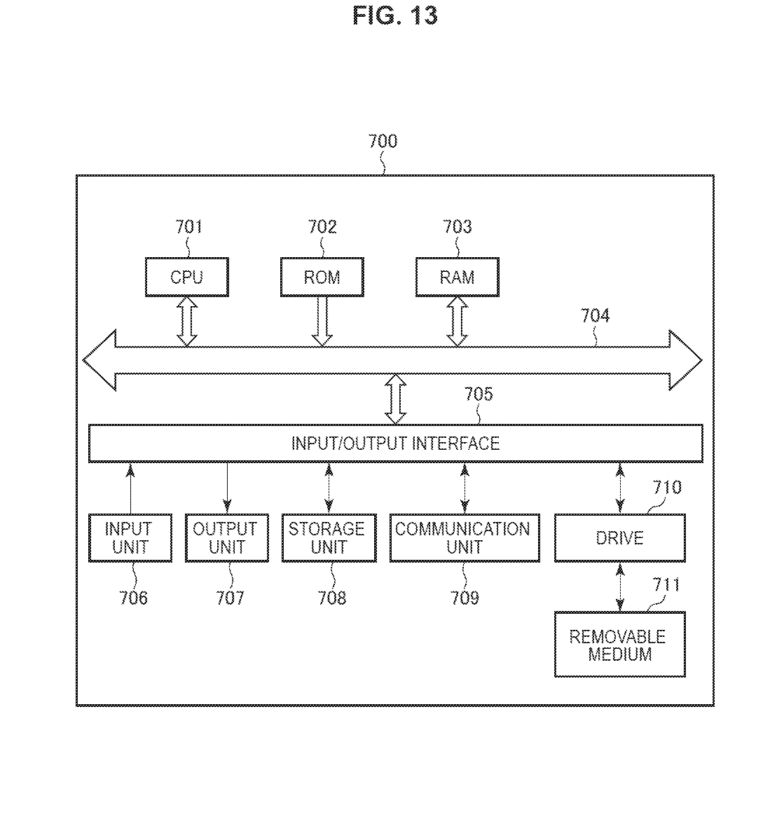

The series of processes described above can be realized by hardware or software. When the series of processes is executed by the software, a program forming the software is installed in a computer embedded in dedicated hardware and a general-purpose personal computer 700 illustrated in FIG. 13 in which various programs can be installed and various functions can be executed, through a network or a recording medium.

In FIG. 13, a CPU 701 executes various processes according to a program stored in a read only memory (ROM) 702 or a program loaded from a storage unit 708 to a RAM 703. In the RAM 703, data that is necessary for executing the various processes by the CPU 701 is appropriately stored.

The CPU 701, the ROM 702, and the RAM 703 are connected mutually by a bus 704. Also, an input/output interface 705 is connected to the bus 704.

An input unit 706 that includes a keyboard and a mouse, an output unit 707 that includes a display composed of a liquid crystal display (LCD) and a speaker, a storage unit 708 that is configured using a hard disk, and a communication unit 709 that is configured using a modem and a network interface card such as a LAN card are connected to the input/output interface 705. The communication unit 709 executes communication processing through a network including the Internet.

A drive 710 is connected to the input/output interface 705 according to necessity, removable media 711 such as a magnetic disk, an optical disc, a magneto optical disc, or a semiconductor memory are appropriately mounted, and a computer program that is read from the removable media 711 is installed in the storage unit 708 according to necessity.

When the series of processes is executed by the software, a program forming the software is installed through the network such as the Internet or a recording medium composed of the removable media 711.

The recording medium may be configured using the removable media 711 illustrated in FIG. 13 that is composed of a magnetic disk (including a floppy disk (registered trademark)), an optical disc (including a compact disc-read only memory (CD-ROM) and a digital versatile disc (DVD)), a magneto optical disc (including a mini-disc (MD) (registered trademark)), or a semiconductor memory, which is distributed to provide a program to a user and has a recorded program, different from a device body, and may be configured using a hard disk that is included in the ROM 702 provided to the user in a state embedded in the device body in advance having a recorded program or the storage unit 708.

In the present disclosure, the series of processes includes a process that is executed in the order described, but the process is not necessarily executed temporally and can be executed in parallel or individually.

The embodiment of the present technology is not limited to the above-described embodiment. It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus including:
a table saving unit configured to copy an address conversion table stored in a first storage area of a memory to a storage area other than the first storage area and save the copied address conversion table;
a table recovery unit configured to recover the address conversion table of a saving time point by copying the saved address conversion table to the first storage area of the memory; and
a rewrite control unit configured to, when there is a rewrite request for data of a virtual address associated with a physical address on the address conversion table after the address conversion table has been saved, change the physical address associated with the virtual address, and cause the rewritten data to be stored in a storage area corresponding to the changed physical address.

(2) The information processing apparatus according to (1),
wherein the address conversion table is generated for an application program,
wherein the information processing apparatus further includes a program notification unit configured to specify an application program to be executed and notify the table recovery unit of the specified application program, and
wherein the table recovery unit recovers the address conversion table of the saving time point when the address conversion table corresponding to the application program is saved at a point in time at which the application program is executed.

(3) The information processing apparatus according to (2),
wherein the program notification unit further senses an end of the execution of the application program and notifies the rewrite control unit of the sensed execution end, and
wherein the rewrite control unit erases the rewritten data stored in the storage area corresponding to the changed physical address when notified of the end of the execution of the application program.

(4) The information processing apparatus according to (2), further including:
an execution presence/absence information notification unit configured to notify the table recovery unit of information indicating whether the application program has been previously executed when the application program is executed,
wherein the table recovery unit recovers the address conversion table when notified of the information indicating whether the application program has been previously executed.

(5) The information processing apparatus according to any one of (1) to (4), wherein the memory is a nonvolatile memory.

(6) The information processing apparatus according to any one of (1) to (5), further including:
a memory holding unit configured to supply power to the memory,
wherein the memory is a volatile memory.

(7) The information processing apparatus according to any one of (1) to (6), wherein the table saving unit saves the address conversion table at a predetermined time interval.

(8) The information processing apparatus according to any one of (1) to (7), wherein the table saving unit saves the address conversion table when a predetermined event has been generated while an application program is in operation.

(9) The information processing apparatus according to any one of (1) to (8),
wherein the table saving unit saves the address conversion table at a plurality of time points, and
wherein the table recovery unit recovers an address conversion table of a designated time point among address conversion tables of the plurality of time points.

(10) The information processing apparatus according to (9),
wherein the address recovery unit recovers an address conversion table of a designated time point based on an operation of a user, and
wherein, when the address conversion table of the designated time point is not saved, the address recovery unit controls a display of a message for notifying the user that the address conversion table is not capable of being recovered.

(11) An information processing method including:
copying, by a table saving unit, an address conversion table stored in a first storage area of a memory to a storage area other than the first storage area and saving the copied address conversion table;
recovering, by a table recovery unit, the address conversion table of a saving time point by copying the saved address conversion table to the first storage area of the memory; and
changing, by a rewrite control unit, when there is a rewrite request for data of a virtual address associated with a physical address on the address conversion table after the address conversion table has been saved, the physical address associated with the virtual address, and causing the rewritten data to be stored in a storage area corresponding to the changed physical address.

(12) A program for causing a computer to function as an information processing apparatus, the information processing apparatus including
a table saving unit configured to copy an address conversion table stored in a first storage area of a memory to a storage area other than the first storage area and save the copied address conversion table,
a table recovery unit configured to recover the address conversion table of a saving time point by copying the saved address conversion table to the first storage area of the memory, and
a rewrite control unit configured to, when there is a rewrite request for data of a virtual address associated with a physical address on the address conversion table after the address conversion table has been saved, change the physical address associated with the virtual address, and cause the rewritten data to be stored in a storage area corresponding to the changed physical address.

The present disclosure contains subject matter related to that disclosed in Japanese Priority Patent Application JP 2012-132557 filed in the Japan Patent Office on Jun. 12, 2012, the entire content of which is hereby incorporated by reference.

What is claimed is:

1. An information processing apparatus comprising:
a table saving unit configured to copy an address conversion table stored in a first storage area of a memory to a storage area other than the first storage area and save the copied address conversion table;
a table recovery unit configured to recover the address conversion table of a saving time point by copying the saved address conversion table to the first storage area of the memory; and
a rewrite control unit configured to, when there is a rewrite request for data of a virtual address associated with a physical address on the address conversion table after the address conversion table has been saved, change the physical address associated with the virtual address, and cause the rewritten data to be stored in a storage area corresponding to the changed physical address.

2. The information processing apparatus according to claim 1,
wherein the address conversion table is generated for an application program,
wherein the information processing apparatus further comprises a program notification unit configured to specify an application program to be executed and notify the table recovery unit of the specified application program, and
wherein the table recovery unit recovers the address conversion table of the saving time point when the address conversion table corresponding to the application program is saved at a point in time at which the application program is executed.

3. The information processing apparatus according to claim 2,
wherein the program notification unit further senses an end of the execution of the application program and notifies the rewrite control unit of the sensed execution end, and
wherein the rewrite control unit erases the rewritten data stored in the storage area corresponding to the changed physical address when notified of the end of the execution of the application program.

4. The information processing apparatus according to claim 2, further comprising:
an execution presence/absence information notification unit configured to notify the table recovery unit of information indicating whether the application program has been previously executed when the application program is executed,
wherein the table recovery unit recovers the address conversion table when notified of the information indicating whether the application program has been previously executed.

5. The information processing apparatus according to claim 1, wherein the memory is a nonvolatile memory.

6. The information processing apparatus according to claim 1, further comprising:
a memory holding unit configured to supply power to the memory,
wherein the memory is a volatile memory.

7. The information processing apparatus according to claim 1, wherein the table saving unit saves the address conversion table at a predetermined time interval.

8. The information processing apparatus according to claim 1, wherein the table saving unit saves the address conversion table when a predetermined event has been generated while an application program is in operation.

9. The information processing apparatus according to claim 1,
wherein the table saving unit saves the address conversion table at a plurality of time points, and
wherein the table recovery unit recovers an address conversion table of a designated time point among address conversion tables of the plurality of time points.

10. The information processing apparatus according to claim 9,
wherein the address recovery unit recovers an address conversion table of a designated time point based on an operation of a user, and
wherein, when the address conversion table of the designated time point is not saved, the address recovery unit controls a display of a message for notifying the user that the address conversion table is not capable of being recovered.

11. An information processing method comprising:
copying, by a table saving unit, an address conversion table stored in a first storage area of a memory to a storage area other than the first storage area and saving the copied address conversion table;
recovering, by a table recovery unit, the address conversion table of a saving time point by copying the saved address conversion table to the first storage area of the memory; and
changing, by a rewrite control unit, when there is a rewrite request for data of a virtual address associated with a physical address on the address conversion table after the address conversion table has been saved, the physical address associated with the virtual address, and causing the rewritten data to be stored in a storage area corresponding to the changed physical address.

12. A program for causing a computer to function as an information processing apparatus, the information processing apparatus including
a table saving unit configured to copy an address conversion table stored in a first storage area of a memory to a storage area other than the first storage area and save the copied address conversion table,
a table recovery unit configured to recover the address conversion table of a saving time point by copying the saved address conversion table to the first storage area of the memory, and
a rewrite control unit configured to, when there is a rewrite request for data of a virtual address associated with a physical address on the address conversion table after the address conversion table has been saved, change the physical address associated with the virtual address, and cause the rewritten data to be stored in a storage area corresponding to the changed physical address.
